(19) United States
(12) Patent Application Publication
(10) Pub. No.: US 2017/0337632 A1
(43) Pub. Date: Nov. 23, 2017

(54) SYSTEMS AND METHODS FOR CALCULATING A WEALTH SCORE

(71) Applicant: KIRIN DOMBEK, Holmdel, NJ (US)

(72) Inventor: KIRIN DOMBEK, Holmdel, NJ (US)

(21) Appl. No.: 15/157,116

(22) Filed: May 17, 2016

(51) Int. Cl. G06Q 40/06

(52) U.S. Cl. CPC G06Q 40/06

(57) ABSTRACT

A system and an apparatus may include: a memory coupled to at least one processor, the at least one processor being configured to execute a method to determine a risk adjusted wealth score based on a variety of parameters and data such that a user can be made aware of a likelihood of achieving a financial goal.

### BACKGROUND

### Technical Field

The present disclosure relates to electronic devices, in general, and, more particularly, to a method and apparatus for determining the likelihood of meeting a financial goal.

### Description of the Related Art

While every generation has its own set of challenges and adversities to overcome, the current generation of millennial (i.e., those who reached young adulthood around the year 2000) face a uniquely challenging financial environment resulting from a variety of events including, for example, the fall of companies like Enron™ and WorldCom™, the housing bubble and the economic crisis of 2008. Such events have contributed to an “economic post-traumatic stress disorder” and ongoing economic difficulties for millennials.

For those who graduated college between the years 2006 and 2010, 14% cannot find full-time work and only 55.3% of young adults aged 16-29 have jobs. With such problems, retirement planning is at the bottom of most to-do lists for those within this age bracket. However, long-term financial security remains important for everyone.

Conventional methods for calculating financial goals, retirement gaps, and more generally, trends in one's financial health, work poorly for millennials because there are an increasing number of factors that were not considered by those models.

Accordingly, new methods and systems for calculating one's financial health and goals are needed.

### SUMMARY

The present disclosure relates to a methods and systems based on statistical and mathematical approaches that allow a user to easily and quickly perform a variety of calculations relating to, for example, financial planning, financial goal calculation, retirement gap calculation planning, wealth accumulation, and pension analysis. In an embodiment of the present disclosure, a method and system for calculating the likelihood of meeting financial objectives is disclosed.

An apparatus in accordance with the present disclosure may include a computing device including a display, a memory coupled to at least one processor, the at least one processor being configured to: execute a method to determine a wealth score, wherein the method calculates a wealth score based upon a projected income, a projected contribution to savings, and a projected portfolio balance based upon a plurality of parameters. Statistical data may be applied to determine a statistical annual investment yield and wherein the wealth score is adjusted based upon a risk profile of a user, and displaying the wealth score. The parameters may include a current age of a user, an expected retirement age of the user, a current income of the user, and a credit score of the user. The data and parameters utilized in the method may be updated in real-time.

The method executed by the apparatus may include: forecasting the projected income based upon an age of the user and an expected retirement age of the user; forecasting the projected contribution based upon a contribution rate, a credit risk, the age of the user, and the expected retirement age of the user; forecasting an investment portfolio balance based upon the projected income and the projected contribution, the age of the user, and the expected retirement age of the user; calculating the wealth score based upon the projected portfolio balance, expected lifespan after retirement, average income before retirement, and desired percentage of income at retirement; and adjusting the wealth score based on a risk factor.

More particularly, the method of calculating a likelihood of meeting a financial objective may be based on a plurality of parameters that are specific to particular user including, for example, the following: (1) age; (2) annual gross income; (3) initial contribution to an investment account to start retirement savings; (4) non-discretionary expenses; (5) discretionary expenses; (6) credit score; and (7) whether the user has identity protection insurance. Other parameters are also considered but are not user specific as they are the same for all users. These parameters include: (1) tax rate (Rₜₐₓ), which is specific for individuals within a particular tax bracket); (2) inflation rate (R_{inf}); (3) retirement horizon, i.e., age of retirement; (4) retirement longevity (RL), which is the expected lifespan of the user after retirement; (5) a retirement discount factor (RDF), which is the percent of the user's average annual income that is desired for retirement (e.g., 70%); (6) an income growth rate (R_{inc}), which is an annual rate of personal income growth; (7) a credit risk factor for identity protection (GRIP), which is a credit risk factor resulting from a lack of identity protection insurance; (8) a credit risk factor for bad credit score (CRCS), which is a credit risk factor resulting from a low credit score; and (9) an investment rate (Rᵢₙᵥ), which is an expected investment rate for the user's investment account.

The likelihood of meeting the financial objective may be provided by a risk adjusted wealth score, which corresponds to a percentage of likelihood of meeting the financial objective. At least some of the above described parameters are used to determine the user's projected income and savings overtime such that the likelihood of meeting a particular financial objective can be provided. To that end, a combined credit risk factor may be calculated by adding CRIP to the quantity CRCS multiplied by a constant divided by the user's credit score, where the constant may be 300, which is the worst possible credit score out of 850 as traditionally scored. Also, a real investment rate (Rᵣₑₐₗ) which takes into account the inflation rate may be calculated, Rᵣₑₐₗ is equal to the investment rate (Rᵢₙᵥ) (an expected investment rate for one's investment account) minus the inflation rate (R_{inf}). Also, the monthly net income may be calculated by subtracting the percentage thereof which is taxed, in particular, the monthly net income may be calculated by taking the portion of the yearly income that is not lost to taxes and dividing by the number of months in the year, i.e., 12. In addition, the contribution rate, i.e., the portion of the monthly income that may be contributed to the retirement investment account may be calculated by subtracting from the monthly net income the user's expenses including both discretionary and non-discretionary expenses and dividing by the monthly net income. Forecasting user's financial balance until the user's retirement age is determined by the following equation: Projected Incomeᵢ=Projected Incomeᵢ₋₁*(1+R_{inc}−R_{inf}), where current age<i≦retirement age. The user's portfolio balance may be calculated as a function of the initial contribution to the user's savings and the projected contribution, and may be calculated by adding the contribution to the projected balance and multiplying by the quantity of 1 plus Rᵣₑₐₗ. In particular, the portfolio balance at the user's retirement may be determined by the following equation: (Portfolio Balanceᵢ₋₁+Contributionᵢ)*(1+Rᵣₑₐₗ), where current age<i≦retirement age. The average income may be determined by taking the sum of the projected income for a given number of years and dividing the the given number of years.

For example, the average income over 10 years may be provided by the following equation:

Income_{average}=Σ_{i=retirement age-10}^{retirement age}PIᵢ/10.

Thereafter, a raw wealth score (RWS) may be calculated. The RWS is a function of the portfolio balance at the retirement age, the retirement horizon (RL) (i.e., age of retirement), the average income, and a retirement discount factor (RDF) (i.e., a percent of the user's average annual income that is desired for retirement (e.g., 70%)).

In particular, RWS may be provided by the following equation:

$$RWS = \frac{{( Portfolio Balance )}_{retirement age}}{RL} * ( {Income}_{avg} * RDF ) * 100 \%$$

The RWS may be adjusted for risk. For example, a risk adjusted wealth score (RAWS)=RWS*(I−Risk Factor), where Risk Factor is a constant value for a particular age.

The above and other aspects, features and advantages of the present disclosure will become apparent from the following description read in conjunction with the accompanying drawings, in which like reference numerals designate the same elements.

### BRIEF DESCRIPTION OF THE DRAWINGS

FIG. 1 is a diagram of an example of a system according to aspects of the present disclosure;

FIG. 2 is a diagram of an example of a client device according to aspects of the present disclosure;

FIG. 3 is a diagram depicting a system according to aspects of the present disclosure;

FIG. 4 is a diagram depicting the interrelationship between various components of a system according to aspects of the present disclosure;

FIG. 5 depicts steps of a method utilized by a system according to aspects of the present disclosure;

FIG. 6 depicts a flowchart detailing steps of a portion of the method according to aspects of the present disclosure;

FIG. 7 depicts a flowchart detailing steps of a portion of the method according to aspects to the present disclosure; and

FIG. 8 depicts a diagram detailing factors considered in determining one of the parameters of the method according to aspects of the present disclosure.

### DETAILED DESCRIPTION

Reference will now be made in detail to embodiments of the invention. Wherever possible, same or similar reference numerals are used in the drawings and the description to refer to the same or like parts or steps. The drawings are in simplified form and are provided only for illustrative purposes.

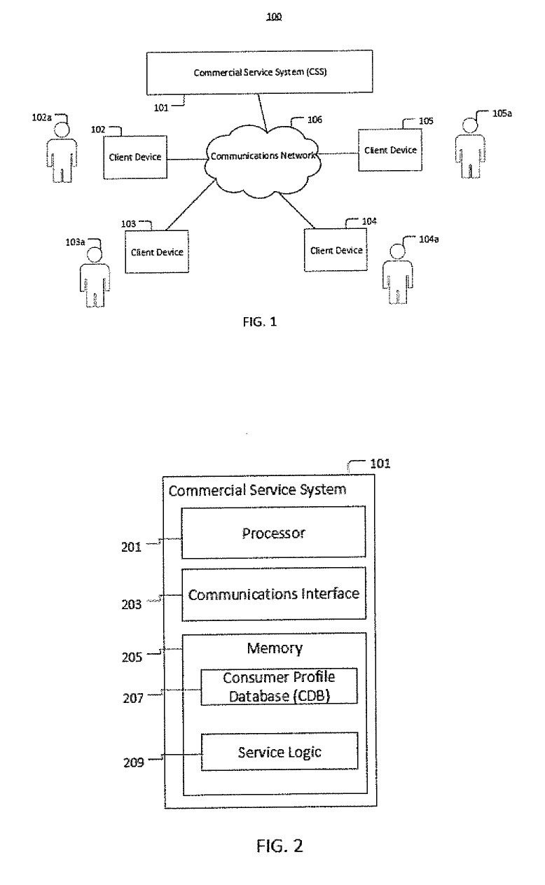

FIG. 1 is a diagram of an example of a system 100 according to aspects of the disclosure. As illustrated, the system 100 may include a commercial service system (CSS) 101, client devices 102-105, and a communications network 106.

According to aspects of the disclosure, the CSS 101 may include one or more servers (e.g., a single server, a server farm, etc.) that are used to provide a commercial service (e.g., a stock portfolio management service). In operation, CSS 101 may maintain a consumer or user profile database (CDB) that includes records for the consumer or users who have joined the commercial service (e.g., the members of the service). Additionally, or alternatively, the CSS may include hardware and/or software for performing stock trading transactions and/or any other suitable type of transaction on behalf of the consumer or users who have joined the service.

The client devices 102-105 may include any suitable type of computing device. For example, any of the client devices 102-105 may include a smartphone, a desktop computer, a laptop, a gaming console, a digital media player, etc. The communications network 106 may include one or more of a local area network (LAN), a wide area network (WAN), a wireless network (e.g., 802.11, 4G, etc.), and or any other suitable type of network. Each of the client devices 102-105 may be associated with a respective user 102a-105a who is a member of the service.

FIG. 2 is a diagram of an example of the commercial service system (CSS) 101, according to aspects of the disclosure. As illustrated, the CSS 101 includes a processor 201, a communications interface 203, and a memory 205. According to aspects of the disclosure, the processor 201 may include any suitable type of processing circuitry, such as a general-purpose processor (e.g., an ARM-based processor), an application-specific integrated circuit (ASIC), or a Field-Programmable Gate Array (FPGA). The communications interface 203 may include any suitable type of communications interface, such as a WiFi interface, an Ethernet interface, a Long-Term Evolution (LTE) interface, a Bluetooth Interface, an Infrared interface, etc. The memory 205 may include any suitable type of volatile and non-volatile memory, such as random-access memory (RAM), read-only memory (ROM), a hard disk (HD), a solid state drive (SSD), a CD-ROM, flash memory, cloud storage, or network accessible storage (NAS). In some implementations, the memory 205 may store a consumer or user profile database (CDB) 207 and service logic 209.

The CDB 207 may include any suitable type of data structure that is arranged to store one or more consumer or user profile records. By way of example, the CDB 207 may include one or more of a file system folder, a relational database, an SQL database, etc. Each profile record may include a data structure containing consumer or user profile information.

The service logic 209 may include one or more of a load balancer, a service frontend that is arranged to interface with instances of a mobile application (e.g. an App) that are executed on the client devices 102-105, and a service backend arranged to provide the particular service. For example, the service backend may be arranged to provide various portfolio management functions, such as buying stock, selling of stock, generating of portfolio reports. Additionally or alternatively, as another example, the service backend may implement an online store, a shopping cart, a billing system, etc.

Although in this example the CSS 101 is presented as an integral device, in some implementations the CSS 101 may be implemented as a network of computers, and/or a server farm. For instance, the CDB 207 and the service logic 209 may be hosted on different computers. Moreover, any of the CDB 207 and the service logic 209 may be hosted on multiple computers.

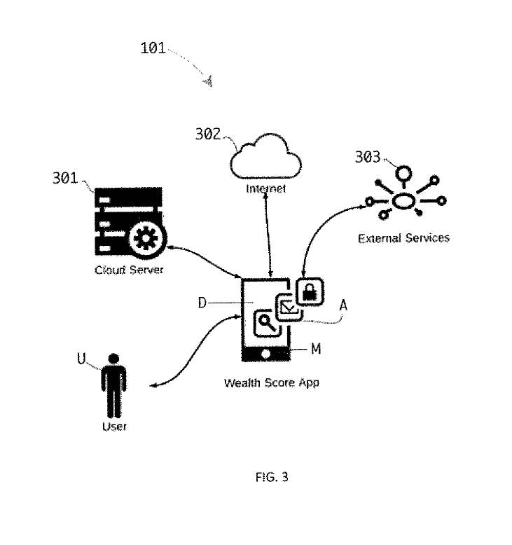

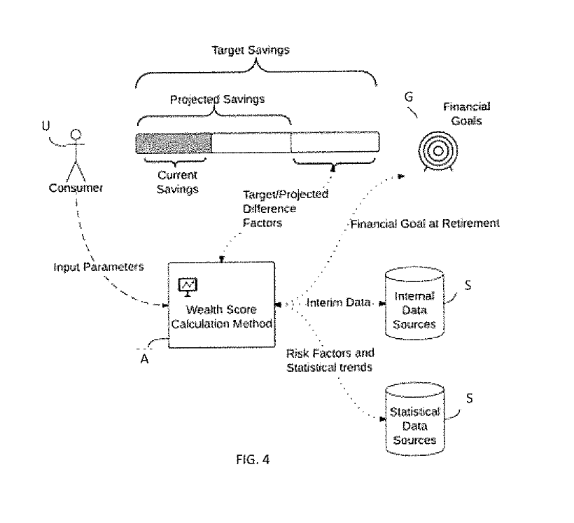

In particular, as shown in FIG. 3, the CSS 101 is depicted as including multiple computing devices 301-303 which may include a cloud server 301, the Internet 302, external service(s) 303, as well as a mobile terminal M (e.g., a smartphone) which includes an application A running thereon and a display D. The application A referred to herein as a “wealth score” app or application provides consumer or user U with a wealth score that may be displayed on the display D of the mobile terminal M. It is to be understood that the mobile terminal M described herein may be any computing device including, for example, a personal computer. The wealth score corresponds to a likelihood of a user U of reaching a particular financial goal. The wealth score may be based upon inputs and data inputted by or received from the user U and the other computing devices 301-303. For example, the application A may instruct the mobile device M to receive information from the computing devices 301-303 or to request said computing devices 301-303 to perform various calculations. For example, the external services 303 may communicate a variety of information such as, for example, a credit score or other information from a credit bureau, e.g., a credit reporting and/or scoring bureau.

The wealth score calculation method utilizes an algorithm that is a function of various inputs, parameters and/or data. For example, the wealth score algorithm may take at least one of the following inputs into consideration: age, initial contribution to savings, income, retirement savings, contribution rate (e.g., percent of income saved), spending (e.g., non-discretionary spending), input safety net (e.g., other sources of wealth or income), credit score, and/or identity protection.

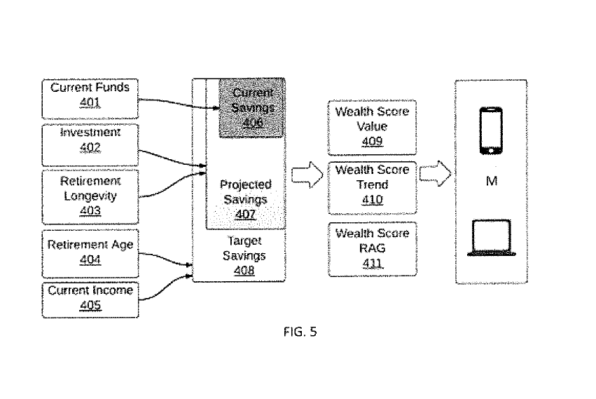

FIG. 4 depicts a block diagram depicting how data and parameters are used to generate a wealth score. In particular, consumer or user U may try to achieve certain financial goal(s) G. These financial goals G may include for example saving a certain amount of money by retirement and/or having an income from savings of a certain amount by retirement. The user's current, projected, and targeted savings define the user's financial path toward the financial goals G and serve as a primary input for wealth score app A to perform a calculation which instructs the execution of a method, which is a logical aggregation of all available public data sources such as industry indices, trends, historical data, etc.

As shown in FIG. 5, a flow chart details basic input factors 401-405 in the execution of the app A. In particular, the user U may input various information including, for example, the current funds 401, investments 402, retirement longevity 403 (i.e., how many years post retirement one expects to live), retirement age 404, and current income 405. Based on the current funds 401, the current savings 406 of the individual U may be determined, and based on the current funds 401, the investments 402 (which includes various factors like interest, contribution rate, etc.), the projected savings 407 of the user U at retirement may be determined. The target savings 407 is a favor of the current savings 406, the projected savings 407, as well as, the retirement age 404 and the current income 405. Based on the calculated current savings 406, the projected savings 407, and the target savings 408, a wealth score 409 can be determined. In addition, a wealth score trend 410 (e.g., an increasing or decreasing likelihood of meeting one's financial goals G) may be determined, as well as a wealth score RAG 411, which may be a wealth score indicator for a range of scores. In particular, RAG may be an indicator light indicating a red light, an amber light, and a green light, where a red light indicates that a person's wealth score is inadequate or the wealth score trend is negative, whereas an amber light may be neutral, and a green light may be positive. The wealth score 409, the wealth score trend 410, and the wealth score RAG 411 may be displayed on the user's computer or mobile terminal M.

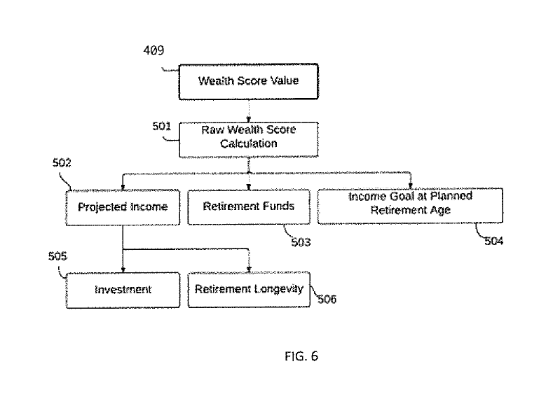

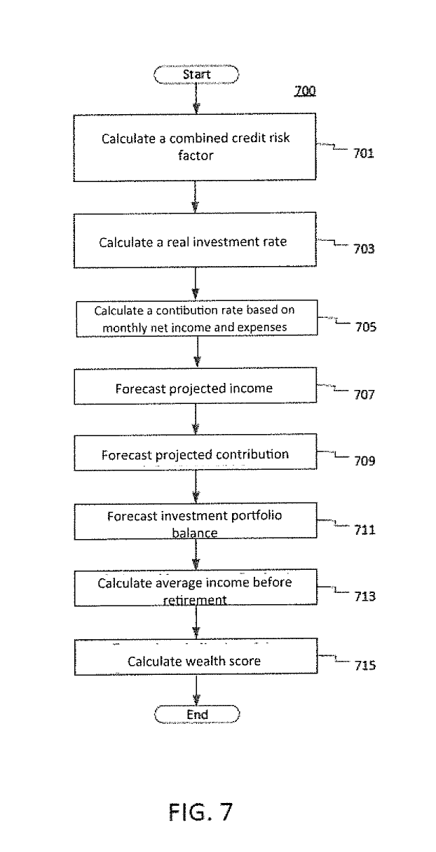

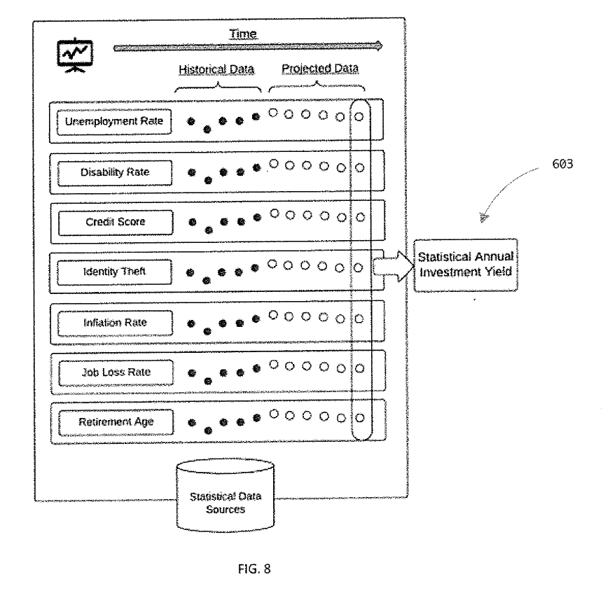

FIG. 6 depicts a flowchart which is shown as a factor tree. For example, the wealth score value 409 is based upon a raw wealth score calculation 501, which in turn is based upon projected income 502, retirement funds 503, and income goal at planned retirement age 504. The projected income 502 is based upon investment 505 and retirement longevity 506. Similarly, the investment 402 is determined by the previous investments 602, the inflation index 604, the current year contribution 602, and the statistical annual investment yield 603. As shown in FIG. 8, statistical data pertaining to a variety of factors including, for example, unemployment rate, disability rate, credit score, identity theft, inflation rate, job loss rate, and retirement age can be used to make projections relating to the investment yield 603.

In an embodiment of the present disclosure, a method of determining the above described wealth score 409 may be based on a plurality of parameters that are specific to particular user including, for example, the following: (1) age; (2) annual gross income; (3) initial contribution to an investment account to start retirement savings; (4) non-discretionary expenses; (5) discretionary expenses; (6) credit score; and (7) whether the user has identity protection insurance. Other parameters are also considered but are not user specific as they are the same for all users. These parameters include: (1) tax rate (Rₜₐₓ), which is specific for individuals within a particular tax bracket); (2) inflation rate (R_{inf}); (3) retirement horizon, i.e., age of retirement; (4) retirement longevity (RL), which is the expected lifespan of the user after retirement; (5) a retirement discount factor (RDF), which is the percent of the user's average annual income that is desired for retirement (e.g., 70%); (6) an income growth rate (R_{inc}), which is an annual rate of personal income growth; (7) a credit risk factor for identity protection (CRIP), which is a credit risk factor resulting from a lack of identity protection insurance; (8) a credit risk factor for bad credit score (CRCS), which is a credit risk factor resulting from a low credit score; and (9) an investment rate (Rᵢₙᵥ), which is an expected investment rate for the user's investment account.

A method 700 of determining a wealth score is shown in FIG. 9. In particular, the steps of determining a wealth score include calculating a combined credit risk factor (701), calculating a real investment rate (703), calculating a contribution rate based on monthly net income and expenses (705), forecasting projected income (707), forecasting projected contribution (709), forecasting investment portfolio balance (711), calculating average income before retirement (713), and/or calculating a wealth score, which may be adjusted based on risk (715). Each of these steps is discussed in more detail below.

In particular, the likelihood of meeting the financial objective may be provided by a risk adjusted wealth score, which corresponds to a percentage of likelihood of meeting the financial objective. At least some of the above described parameters are used to determine the user's projected income and savings overtime such that the likelihood of meeting a particular financial objective can be provided. To that end, at step 701, combined credit risk factor may be calculated by adding CRIP to the quantity CRCS multiplied by a constant divided by the user's credit score, where the constant may be 300, which is the worst possible credit score out of 850 as traditionally scored. Also, at step 702, real investment rate (Rᵣₑₐₗ) which takes into account the inflation rate may be calculated, Rᵣₑₐₗ is equal to the investment rate (Rᵢₙᵥ) (an expected investment rate for one's investment account) minus the inflation rate (R_{inf}). Also, at step 705, the contribution rate may be determined based upon income and tax, for example. In particular, the monthly net income may be calculated by subtracting the percentage thereof which is taxed, in particular, the monthly net income may be calculated by taking the portion of the yearly income that is not lost to taxes and dividing by the number of months in the year, i.e., 12. In addition, the contribution rate, i.e., the portion of the monthly income that may be contributed to the retirement investment account may be calculated by subtracting from the monthly net income the user's expenses including both discretionary and non-discretionary expenses and dividing by the monthly net income.

Steps 707-711, forecast one's financial balance until retirement. Forecasting user's financial balance until the user's retirement age. In particular, at step 707, projected income may be determined by the following equation: Projected Incomeᵢ=Projected Incomeᵢ₋₁*(1+R_{inc}−R_{inf}), where current age<i≦retirement age. At step 709-711, the user's portfolio balance may be calculated as a function of the initial contribution to the user's savings and the projected contribution. In particular, at step 709, the projected contribution is provided by the equation: (Projected Contribution)ᵢ=(Projected Income)ᵢ*(Contribution Rate−Risk_{credit}), where current age<i≦retirement age. Also, at step 711, the portfolio balance at the user's retirement may be determined by the following equation: (Portfolio Balanceᵢ₋₁+Contributionᵢ)*(1+Rᵣₑₐₗ), where current age<i≦retirement age.

Thereafter, at steps 713-715, the average income before retirement and a wealth score may be calculated. In particular, at step 714, the average income may be determined by taking the sum of the projected income for a given number of years and dividing the the given number of years.

For example, the average income over 10 years may be provided by the following equation:

Income_{average}=Σ_{i=retirement age-10}^{retirement age}PIᵢ/10.

Thereafter, at step 715, a raw wealth score (RWS) may be calculated. The RWS is a function of the portfolio balance at the retirement age, the retirement horizon (RL) (i.e., age of retirement), the average income, and a retirement discount factor (RDF) (i.e., a percent of the user's average annual income that is desired for retirement (e.g., 70%)).

In particular, RWS may be provided by the following equation;

$$RWS = \frac{{( Portfolio Balance )}_{retirement age}}{RL} * ( {Income}_{avg} * RDF ) * 100 \%$$

The RWS may be adjusted for risk. For example, a risk adjusted wealth score (RAWS)=RWS*(1−Risk Factor), where Risk Factor is a constant value for a particular age.

Various risk factors can affect a user's ability to reach a financial goal including the user's credit score, the user's lack of identity theft insurance, the user's financial situation, and/or the health of the user. For example, Table 1 below identities various risk factors based upon age and a calculation of the risk factor. The risk factor may be equal to the sum of the risk factors, e.g., for age 25, 0.052+0.100+0.150+0.010=0.40.

TABLE 1
Risk factors that can affect the ability to reach goal:

| Age group | Longevity | id theft | Financial | Health | Risk factor |
|---|---|---|---|---|---|
| 25 | 5.2% | 10% | 15% | 10% | 0.40 |
| 35 | 4.2% | 7% | 12% | 8% | 0.31 |
| 45 | 3.3% | 5% | 9% | 5% | 0.22 |
| 55 | 2.5% | 4% | 5% | 4% | 0.16 |
| 65 | 1.8% | 3% | 2% | 2% | 0.09 |

An example of calculating a wealth score is provided hereinbelow. First, as shown in Table 2, various inputs are entered. An additional input may be a safety net, e.g., income or savings from other sources, e.g., relatives.

TABLE 2
Inputs

| | |
|---|---|
| Age | 25 |
| Income | 120,000 |
| Total Savings | 7,000 |
| Contribution rate | 10.00% |
| Non-discretionary spending | 60,000 |
| Credit score | 730 |
| Identity protection | yes |

Second, a recommended retirement income goal may be provided by the system or may be entered by the user. For example, for the inputs given above, it may be recommended that at retirement, the user have an income of $146,944.

The following additional parameters or assumptions may be provided as shown in Table 3 below.

TABLE 3
Additional Parameters and assumptions utilized in the method.

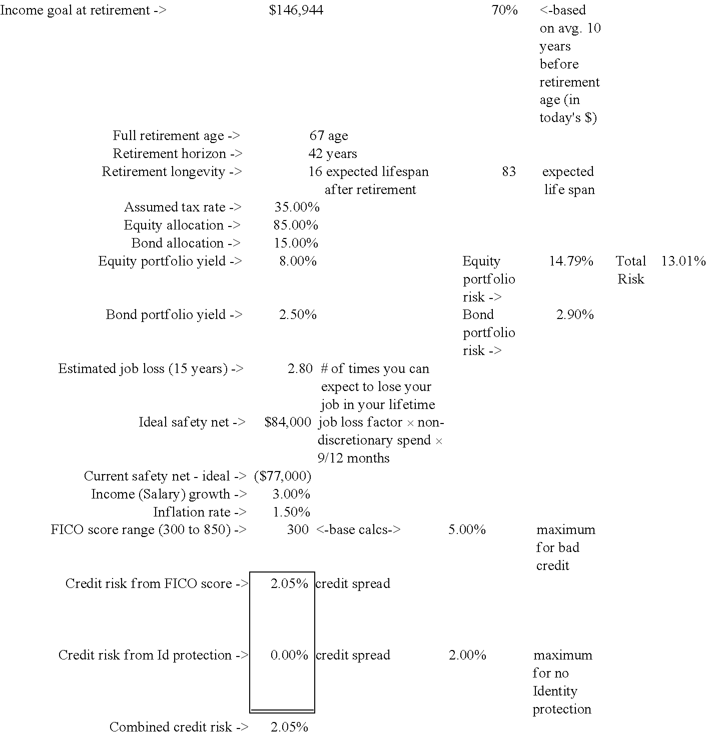

Based on the above, contributions and investments may be forecasted for this example from the user's age 25 until expected death, e.g., age 90, as shown below in Table 4.

TABLE 4
Forecast of retirement horizon including projected
contribution and investments, as well as value of credit risk.

| | | 10 Y | Safety | | | |
|---|---|---|---|---|---|---|
| | | Avg. | net | | | Credit |
| Age | Income | Income | buildup | Contribution | Investment | risk |
| 25 | 120,000 | | | 0 | — | |
| 26 | 121,800 | | $0 | 9,677 | 10,226 | 2,503 |
| 27 | 123,627 | | $0 | 9,822 | 21,187 | 2,540 |
| 28 | 125,481 | | $0 | 9,970 | 32,925 | 2,578 |
| 29 | 127,364 | | $0 | 10,119 | 45,487 | 2,617 |
| 30 | 129,274 | | $0 | 10,271 | 58,922 | 2,656 |
| 31 | 131,213 | | $0 | 10,425 | 73,282 | 2,696 |
| 32 | 133,181 | | $0 | 10,582 | 88,623 | 2,737 |
| 33 | 135,179 | | $0 | 10,740 | 105,002 | 2,778 |
| 34 | 137,207 | 128,433 | $0 | 10,901 | 122,481 | 2,819 |
| 35 | 139,265 | 130,359 | $0 | 11,065 | 141,125 | 2,862 |
| 36 | 141,354 | 132,315 | $0 | 11,231 | 161,002 | 2,905 |
| 37 | 143,474 | 134,299 | $0 | 11,399 | 182,185 | 2,948 |
| 38 | 145,626 | 136,314 | $0 | 11,570 | 204,751 | 2,992 |
| 39 | 147,811 | 138,358 | $0 | 11,744 | 228,781 | 3,037 |
| 40 | 150,028 | 140,434 | $0 | 11,920 | 254,361 | 3,083 |
| 41 | 152,278 | 142,540 | $0 | 12,099 | 281,581 | 3,129 |
| 42 | 154,562 | 144,678 | $0 | 12,280 | 310,538 | 3,176 |
| 43 | 156,881 | 146,849 | $0 | 12,465 | 341,333 | 3,224 |
| 44 | 159,234 | 149,051 | $0 | 12,651 | 374,073 | 3,272 |
| 45 | 161,623 | 151,287 | $0 | 12,841 | 408,872 | 3,321 |
| 46 | 164,047 | 153,556 | $0 | 13,034 | 445,849 | 3,371 |
| 47 | 166,508 | 155,860 | $0 | 13,229 | 485,131 | 3,421 |
| 48 | 169,005 | 158,198 | $0 | 13,428 | 526,852 | 3,473 |
| 49 | 171,540 | 160,571 | $0 | 13,629 | 571,153 | 3,525 |
| 50 | 174,113 | 162,979 | $0 | 13,834 | 618,185 | 3,578 |
| 51 | 176,725 | 165,424 | $0 | 14,041 | 668,105 | 3,631 |
| 52 | 179,376 | 167,905 | $0 | 14,252 | 721,081 | 3,686 |
| 53 | 182,067 | 170,424 | $0 | 14,466 | 777,289 | 3,741 |
| 54 | 184,798 | 172,980 | $0 | 14,683 | 836,915 | 3,797 |
| 55 | 187,570 | 175,575 | $0 | 14,903 | 900,159 | 3,854 |
| 56 | 190,383 | 178,208 | $0 | 15,126 | 967,228 | 3,912 |
| 57 | 193,239 | 180,882 | $0 | 15,353 | 1,038,342 | 3,971 |
| 58 | 196,138 | 183,595 | $0 | 15,584 | 1,113,736 | 4,030 |
| 59 | 199,080 | 186,349 | $0 | 15,817 | 1,193,656 | 4,091 |
| 60 | 202,066 | 189,144 | $0 | 16,055 | 1,278,361 | 4,152 |
| 61 | 205,097 | 191,981 | $0 | 16,295 | 1,368,128 | 4,214 |
| 62 | 208,173 | 194,861 | $0 | 16,540 | 1,463,248 | 4,278 |
| 63 | 211,296 | 197,784 | $0 | 16,788 | 1,564,028 | 4,342 |
| 64 | 214,465 | 200,751 | $0 | 17,040 | 1,670,793 | 4,407 |
| 65 | 217,682 | 203,762 | $0 | 17,295 | 1,783,888 | 4,473 |
| 66 | 220,947 | 206,818 | $0 | 17,555 | 1,903,674 | 4,540 |
| 67 | 224,262 | 209,921 | $0 | 0 | 2,011,708 | 4,608 |
| 68 | 227,626 | 213,069 | $0 | 0 | 2,125,872 | 4,677 |
| 69 | 231,040 | 216,265 | $0 | 0 | 2,246,515 | 4,747 |
| 70 | 234,506 | 219,509 | $0 | 0 | 2,374,005 | 4,819 |
| 71 | 238,023 | 222,802 | $0 | 0 | 2,508,730 | 4,891 |
| 72 | 241,593 | 226,144 | $0 | 0 | 2,651,100 | 4,964 |
| 73 | 245,217 | 229,536 | $0 | 0 | 2,801,550 | 5,039 |
| 74 | 248,896 | 232,979 | $0 | 0 | 2,960,538 | 5,114 |
| 75 | 252,629 | 236,474 | $0 | 0 | 3,128,549 | 5,191 |
| 76 | 256,419 | 240,021 | $0 | 0 | 3,306,094 | 5,269 |
| 77 | 260,265 | 243,621 | $0 | 0 | 3,493,715 | 5,348 |
| 78 | 264,169 | 247,276 | $0 | 0 | 3,691,983 | 5,428 |
| 79 | 268,131 | 250,985 | $0 | 0 | 3,901,503 | 5,510 |
| 80 | 272,153 | 254,750 | $0 | 0 | 4,122,914 | 5,592 |
| 81 | 276,236 | 258,571 | $0 | 0 | 4,356,889 | 5,676 |
| 82 | 280,379 | 262,449 | $0 | 0 | 4,604,142 | 5,761 |
| 83 | 284,585 | 266,386 | $0 | 0 | 4,865,427 | 5,848 |
| 84 | 288,854 | 270,382 | $0 | 0 | 5,141,540 | 5,935 |
| 85 | 293,186 | 274,438 | $0 | 0 | 5,433,323 | 6,024 |
| 86 | 297,584 | 278,554 | $0 | 0 | 5,741,664 | 6,115 |
| 87 | 302,048 | 282,732 | $0 | 0 | 6,067,503 | 6,206 |
| 88 | 306,579 | 286,973 | $0 | 0 | 6,411,834 | 6,300 |
| 89 | 311,177 | 291,278 | $0 | 0 | 6,775,706 | 6,394 |
| 90 | 315,845 | 295,647 | $0 | 0 | 7,160,227 | 6,490 |

As shown below in Table 5 below, a raw and risk adjusted wealth score for the above example is provided, as well as the projected income.

TABLE 5
Calculated Wealth Score

| | Raw | Risk Adjusted |
|---|---|---|
| Score | 86 | 51 |
| Projected income | $125,732 | $75,188 |

The above described embodiments are merely exemplary. At least some of the steps discussed with respect to these figures can be performed concurrently, performed in a different order, and/or altogether omitted. It will be understood that the provision of the examples described herein, as well as clauses phrased as “such as,” “e.g.”, “including”, “in some aspects,” “in some implementations,” and the like should not be interpreted as limiting the claimed subject matter to the specific examples. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

While the present disclosure has been particularly shown and described with reference to the examples provided therein, it will be understood by those skilled in the art that various changes in form and details may be made therein without departing from the spirit and scope of the present disclosure as defined by the appended claims.

Having described at least one of the preferred embodiments of the present invention with reference to the accompanying drawings, it will be apparent to those of skill in the art that the invention is not limited to those precise embodiments, and that various modifications and variations can be made in the presently disclosed system without departing from the scope or spirit of the invention. Thus, it is intended that the present disclosure cover modifications and variations of this disclosure provided they come within the scope of the appended claims and their equivalents.

What is claimed is:

1. An apparatus comprising: a computing device including a display, a memory coupled to at least one processor, the at least one processor being configured to:
execute a method to determine a wealth score, wherein the method calculates a wealth score based upon a projected income, a projected contribution to savings, and a projected portfolio balance based upon a plurality of parameters,
wherein statistical data is applied to determine a statistical annual investment yield and wherein the wealth score is adjusted based upon a risk profile of a user, and displaying the wealth score.

2. The apparatus of claim 1, wherein the parameters and data are updated in realtime.

3. The apparatus of claim 1, wherein the parameters include a current age of a user, an expected retirement age of the user, a current income of the user, and a credit score of the user.

4. The apparatus of claim 1, wherein the method comprises:
forecasting the projected income based upon an age of the user and an expected retirement age of the user;
forecasting the projected contribution based upon a contribution rate, a credit risk, the age of the user, and the expected retirement age of the user;
forecasting an investment portfolio balance based upon the projected income and the projected contribution, the age of the user, and the expected retirement age of the user;
and calculating the wealth score based upon the projected portfolio balance, expected lifespan after retirement, average income before retirement, and desired percentage of income at retirement; and
adjusting the wealth score based on a risk factor.

6. The apparatus of claim 1, wherein the method comprises:
calculating a combined credit risk factor (Risk_{credit}), wherein Risk_{credit} is a function of a credit risk favor for identity protection (CRIP), a credit score, and a credit risk factor for credit score (CRCS), wherein:
$${Risk}_{credit} = CRIP + \frac{K}{CS} * CRCS , where K = a constant ;$$
calculating a real investment rate (Rᵣₑₐₗ), wherein Rᵣₑₐₗ is a function of an investment rate (Rᵢₙᵥ) and an inflation rate (R_{inf}), wherein:
Rᵣₑₐₗ=Rᵢₙᵥ−R_{inf};
calculating an estimated contribution rate (CR), wherein the estimated contribution rate (CR) is equal to a ratio of a monthly net income less discretionary and nondiscretionary expenses to the monthly net income;
calculating the projected income at a retirement age, wherein the projected income is determined based on a current income multiplied an expected income growth rate less R_{inf};
calculating the projected contribution, wherein the projected contribution is equal to the projected income multiplied by a contribution rate less the Risk_{credit};
calculating a portfolio balance, wherein the portfolio balance is equal to a sum of an initial contribution and the projected contribution multiplied by the sum of 1 plus Rᵣₑₐₗ;
calculating an average income before retirement, wherein the average income is equal to the sum of an average of the projected income over several years;
calculating a raw wealth score, the raw wealth score being equal to the portfolio balance divide by an expected number of years of longevity after retirement divided by the average income multiplied by a discount factor; and
calculating a risk adjusted wealth score by multiplying the raw wealth score by a risk factor.
